(19) United States
(12) Patent Application Publication
(10) Pub. No.: US 2009/0132481 A1
(43) Pub. Date: May 21, 2009

(54) WEB SITE REFERRAL INFERENCE

(75) Inventors: Stephen H. Toub, Seattle, WA (US); Joshua I. Hoffman, New York, NY (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/940,331

(22) Filed: Nov. 15, 2007

(51) Int. Cl. G06F 17/30

(52) U.S. Cl. 707/3; 707/E17.108

(57) ABSTRACT

Various technologies and techniques are disclosed for altering web site content based upon information contained in a referring page. A referral request to access a web page is received from a referring web page. The source of the referral request is determined. Content contained in the source is analyzed to infer why the web page was requested. An altered form of the web page is generated based upon the analysis. The web page is rendered in the altered form. A user experience on a web site can be personalized based upon analysis of content on a referring web page. The analysis of the content on the referring source page can be stored in a data store, and used to personalize the content displayed to a user while navigating among web pages on the particular site.

### BACKGROUND

The Internet has expanded the world of commerce and entertainment in incredible ways. There are millions of web sites on the Internet, and that number grows every day. Most web site owners want to attract as many visitors to their site as possible, and want to keep those visitors returning over time. In order to keep visitors coming back, web pages strive to present information to the visitor that is relevant and tailored as much as possible, so that the visitor can find the information they are looking for when they need it.

Many techniques have been used by some existing web sites to help accomplish the goal of making the site worthy of repeat visits. For example, some sites implement personalization engines that track a visitor's interactions with the site and use that information to guess at the visitor's personal tastes and interests. This allows the site to then provide the visitor with a better experience by showcasing content deemed most relevant based on past experience with the visitor. However, these techniques all deal with what happens once a visitor has spent time on the site, and not with what the visitor did before coming to the site.

### SUMMARY

Various technologies and techniques are disclosed for altering web site content based upon information contained in a referring page. A request to access a web page is received from a referring web page. The source of the referral request is determined, such as by accessing the HTTP_REFERER header of the HTTP request for the web page. Content contained in the source of the referrer is analyzed to infer why the web page was requested. An altered form of the requested web page is generated based upon the analysis, and the web page is then rendered in the altered form.

In one implementation, a user experience on a web site can be personalized based upon analysis of content on a referring web page. The analysis performed on the content of the referring source page can be stored in a data store, and used to personalize the content displayed to a user while navigating among web pages on the particular site.

In one implementation, a method is provided for analyzing content on a referring search engine web page to infer why a particular web page was requested. A first catalog is created that contains words used in search results other than the requested web page. A second catalog is created that contains words used in a search result for the requested web page. A list of bad words is created from the first and second catalogs. A list of good words is created from the first and second catalogs. The list of good words and the list of bad words are filtered down to just keywords that are relevant to the requested web page. The filtered list of good words and the filtered list of bad words are used to help determine how to modify the requested web page.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a process flow diagram of one implementation representing the stages involved in analyzing content on a referring page to alter the way a particular web page is rendered.

FIG. 2 is a diagrammatic view of one implementation representing usage of an HTTP_REFERER header to identify the referring page and infer why a particular web page was requested, and alter the rendering of the particular web page accordingly.

FIG. 3 is a process flow diagram of one implementation representing the stages involved in analyzing content on a referring search engine results page to alter the way a particular web page is rendered.

FIG. 4 is a diagrammatic view of one implementation representing usage of an HTTP_REFERER header to identify the referring search engine results page and infer why a particular web page was requested, and alter the rendering of the particular web page accordingly.

FIG. 5 is a process flow diagram for one implementation representing the more detailed stages involved in analyzing content on a referring search engine web page to infer why a particular web page was requested.

FIG. 6 is a simulated screen of one implementation illustrating an exemplary web page in an original form prior to alteration.

FIG. 7 is a simulated screen of one implementation illustrating an exemplary search engine results page that contains a link to the web page of FIG. 6 in the search results.

FIG. 8 is a simulated screen of one implementation illustrating the exemplary web page from FIG. 6 after it has been altered based upon an analysis of the content of the search result of FIG. 7.

FIG. 9 is a process flow diagram for one implementation illustrating the stages involved in using an analysis of a referring page for personalizing a user's experience throughout a web site.

FIG. 10 is a process flow diagram for one implementation illustrating the stages involved in asynchronously analyzing content contained in a referring web page to a particular site and associating the analysis results with the current session on the particular site.

FIG. 11 is a process flow diagram for one implementation illustrating the stages involved in logging referring information for later analysis.

FIG. 12 is a process flow diagram for one implementation illustrating the stages involved in handling the alteration of the web page using a client-side script.

FIG. 13 is a process flow diagram for one implementation illustrating the stages involved in using cached results to optimize analysis of referring web site content.

FIG. 14 is a diagrammatic view of a computer system of one implementation.

### DETAILED DESCRIPTION

The technologies and techniques herein may be described in the general context as an application that analyzes information in a referring web page to alter content displayed in a requested web page, but the technologies and techniques also serve other purposes in addition to these. In one implementation, one or more of the techniques described herein can be implemented as features within any type of web site that wants to provide a personalized user experience. In another implementation, some of the features can be implemented within a web site search engine.

As it turns out, there is a wealth of information that can be gleaned about a user on their very first visit to a web page, based on where that user came from. When a user using a web browser clicks on a link in the browser, the browser requests the page at the address specified in that link. Along with that request, as part of the HTTP headers, it includes an HTTP_REFERER value equal to the address of the current page—the page containing the link being clicked on. In this fashion, a page being requested can frequently determine where the user is coming from. Many sites log this HTTP_REFERER value and use it to later determine where their user base is coming from. But there is a lot more that can be done with this information. In one implementation, a web site referrer inference system is provided that analyzes content contained in a referring web page to determine how to alter the content displayed in the requested web page.

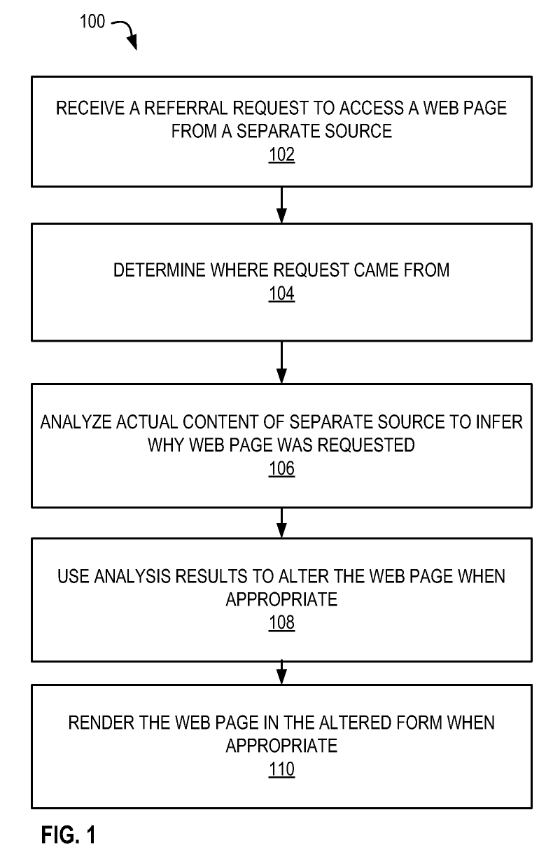

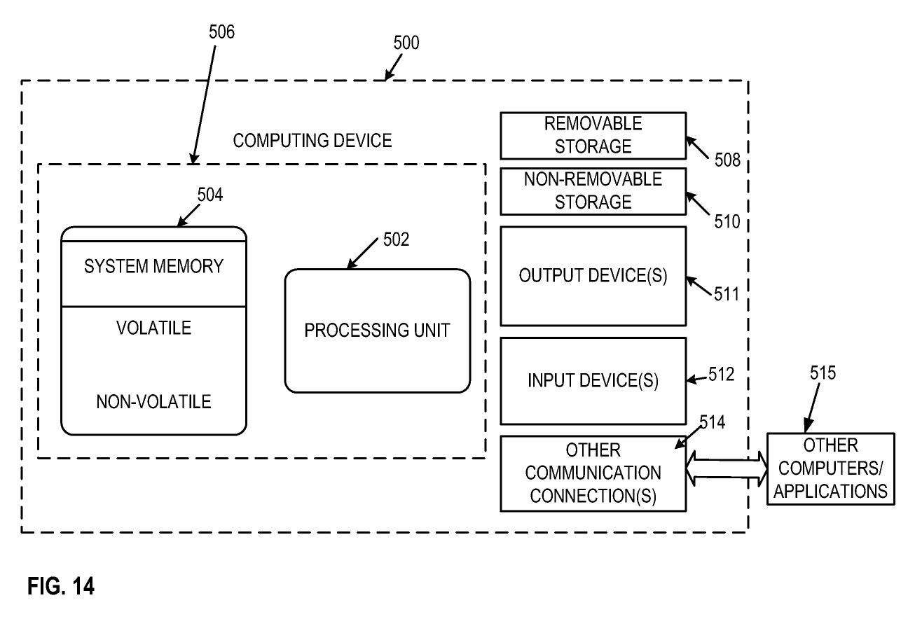

Turning now to FIGS. 1-13, the stages for implementing one or more implementations of a web site referrer inference system are described in further detail. In some implementations, the processes of FIG. 1-13 are at least partially implemented in the operating logic of computing device 500 (of FIG. 14).

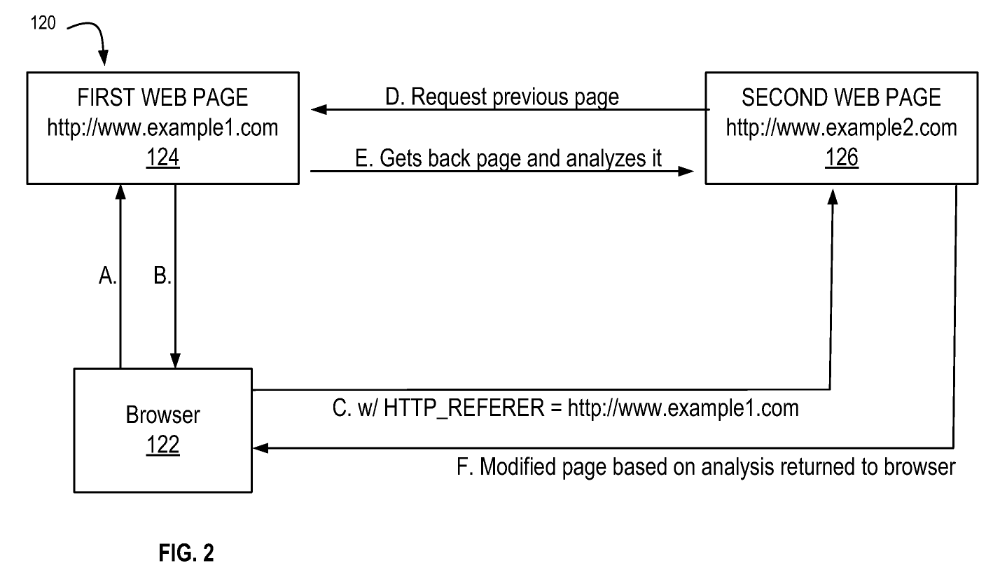

FIG. 1 is a process flow diagram 100 of one implementation representing the stages involved in analyzing content on a referring page to alter the way a particular web page is rendered. A referral request to access a particular web page is received from a separate source (e.g. another web site) (stage 102). A determination is made as to where the request came from (stage 104). In one implementation, as further shown in FIG. 2, an HTTP_REFERER header in the request for a particular web page is analyzed to see what previous web page asked that the web page be loaded. The actual content of the separate source (that referring web page) is analyzed to infer why the web page was requested (stage 106). As a non-limiting example, the words, sentence(s), and/or paragraph(s) surrounding the link can be analyzed to give further insight into what caused the page to be requested (such as why the user to selected a link to access the web page).

The analysis results are then used to alter the web page if an alteration is determined to be appropriate (stage 108). In some instances, the current structure of the web page may already be the most suitable based upon the analysis. In other instances, it is appropriate to modify the structure based upon the analysis. As one non-limiting example, content on the web page can be re-arranged to show items more relevant to the user near the top of the screen or in a more prominent position than other content less relevant to the user. As another non-limiting example, only content that seems relevant to what the user is looking for can be displayed, while other content is simply hidden or removed from the view. Numerous other variations are also possible for how the content can be altered based upon the analysis of the content on the referring page. In one implementation, the content is dynamic and is stored in a database. The system then renders the web page in the altered form (or the original form if no alterations were made) (stage 110). In one implementation, the web page is rendered on a display device to a user. This approach of analyzing content and altering the output will be described in further detail in the example of FIG. 2.

FIG. 2 is a diagrammatic view 120 of one implementation representing usage of an HTTP_REFERER header to identify the referring page and infer why a particular web page was requested, and alter the rendering of the particular web page accordingly. As shown in the figure, a user navigates to a first web page 124 using a web browser 122. While on the first web page 124, the user clicks a link that directs the browser 122 to a second web page 126. Before the second web page 126 is displayed to the user in the browser 122, the HTTP_REFERER header is accessed to determine the URL of the first web page 124 that requested the second web page 126. Once the URL is known, the content at that URL of the first web page 124 is requested by a server hosting the second web page 126. Once the content is received, the second web page 126 (or other suitable process or web page associated with the second web page) analyzes that content to infer why the user clicked on the link to go to the second web page 126. Based upon the analysis, the second web page 126 is modified in some fashion that is believed to better represent what the user is looking for. That altered version of the second web page 126 is then displayed to the user in the browser 122.

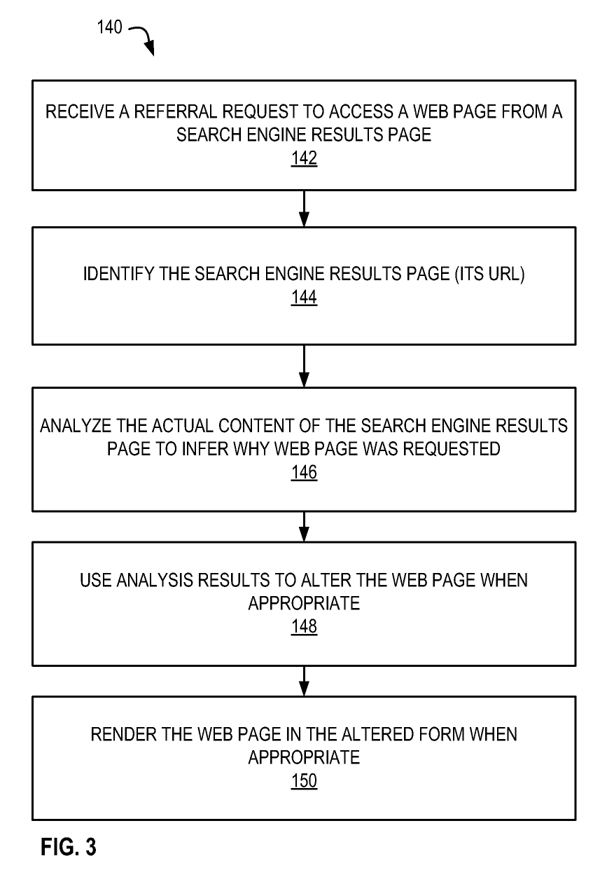

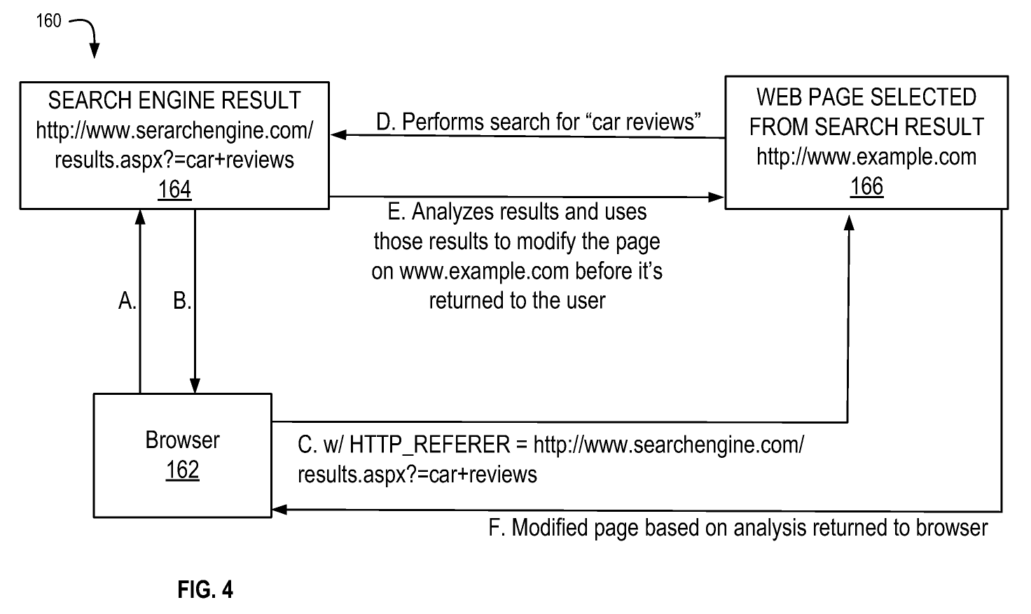

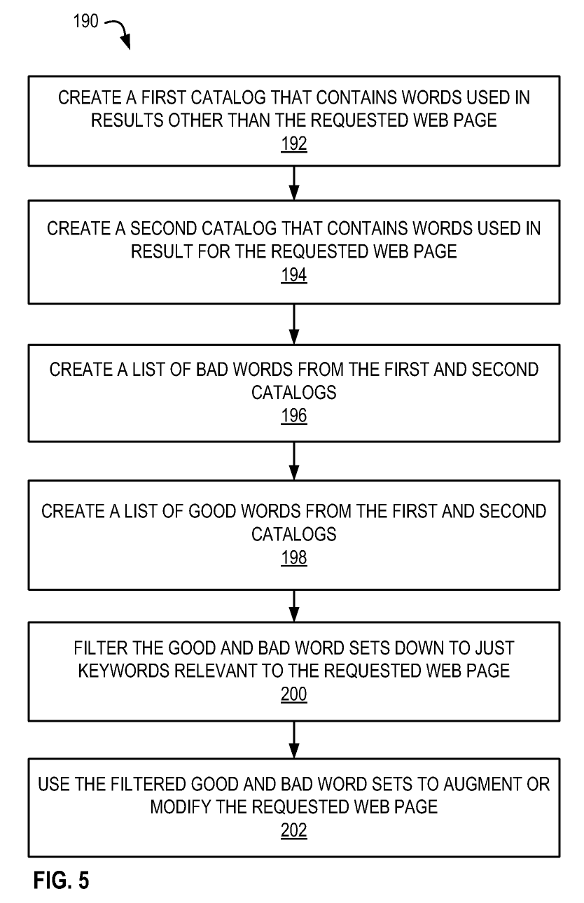

FIG. 3 is a process flow diagram 140 of one implementation representing the stages involved in analyzing content on a referring search engine results page to alter the way a particular web page is rendered. A referral request is received to access a web page from a search engine results page (stage 142). The search engine results page is identified (it's URL) (stage 144), as described in further detail in FIG. 4. The actual content of the search engine results page is analyzed to infer why the particular destination web page was requested from the list of available choices (stage 146). One example of an analysis process that can be performed is described in further detail in FIG. 5. The analysis results are used to alter the web page when an alteration is determined to be appropriate (stage 148). The web page is then rendered in the altered form (or the original form if no alteration was determined necessary) (stage 150).

FIG. 4 is a diagrammatic view of one implementation representing usage of an HTTP_REFERER header to identify the referring search engine results page and infer why a particular web page was requested, and alter the rendering of the particular web page accordingly. As shown in the figure, a user navigates to a search engine result page 164 using a web browser 162. While on the search engine result page 164, the user clicks a search result link that directs the browser 162 to a selected web page 166. Before the selected web page 166 is displayed to the user in the browser 162, the HTTP_REFERER header is accessed to determine the URL of the search engine result page 164 that requested the selected web page 166. Once the URL is known, the content at that URL of the search engine result page 164 is requested by the selected web page 166. Once the content is received, the selected web page 166 (or other suitable process or web page associated with the selected web page) analyzes that content to infer why the user clicked on the search result link to go to the selected web page 166. Based upon the analysis, the selected web page 166 is modified in some fashion that is believed to better represent what the user is looking for. That altered version of the selected web page 166 is then displayed to the user in the browser 162.

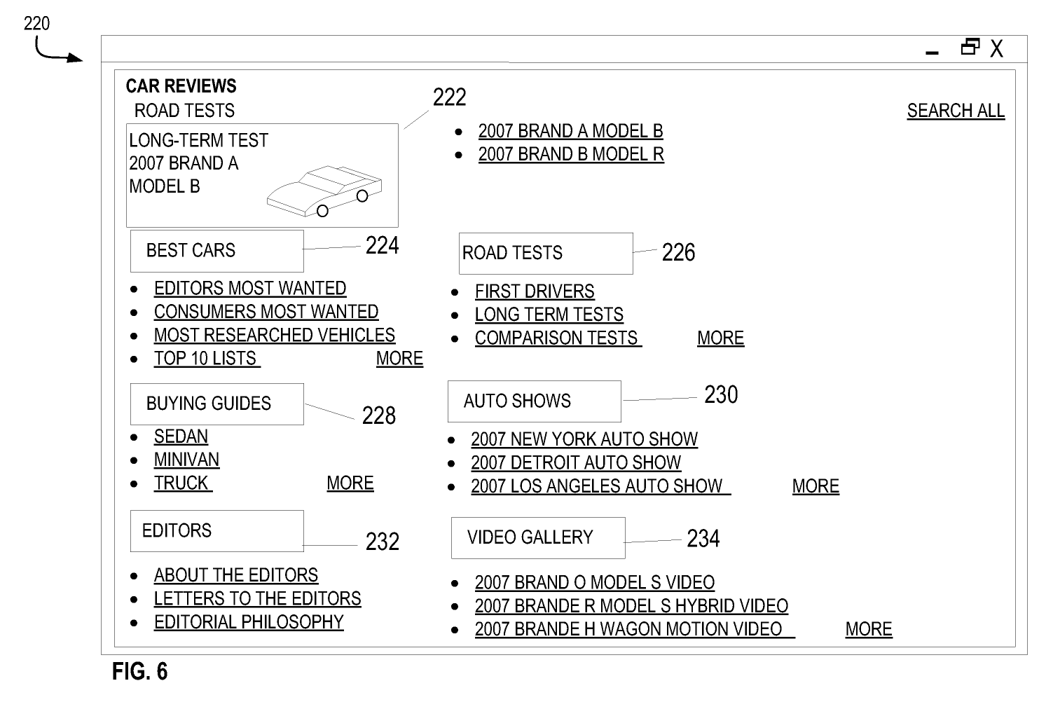

Turning now to FIG. 5, a process flow diagram 190 for one implementation is shown that illustrates the stages involved in analyzing content on a referring search engine web page to infer why a particular web page was requested. A first catalog is created that contains words used in the results other than for the requested web page (stage 192). The term “words” as used herein is meant to include one or more words, phrases, and/or other groupings of words or phrases. A second catalog is created that contains words used in the result for the requested web page (stage 194). A list of bad words is created from the first and second catalogs (stage 196), where a bad word is one that appears in both the results of the requested web page and of other web pages. A list of good words is created from the first and second catalogs (stage 198), where a good word is one that only appears in the search result of the requested web page. The good and bad word sets are filtered down to just keywords relevant to the requested web page (stage 200). The filtered good and bad word sets are used to augment or modify the requested web page (stage 202). An example of how this process works will be further illustrated in the simulated screens of FIGS. 6-8.

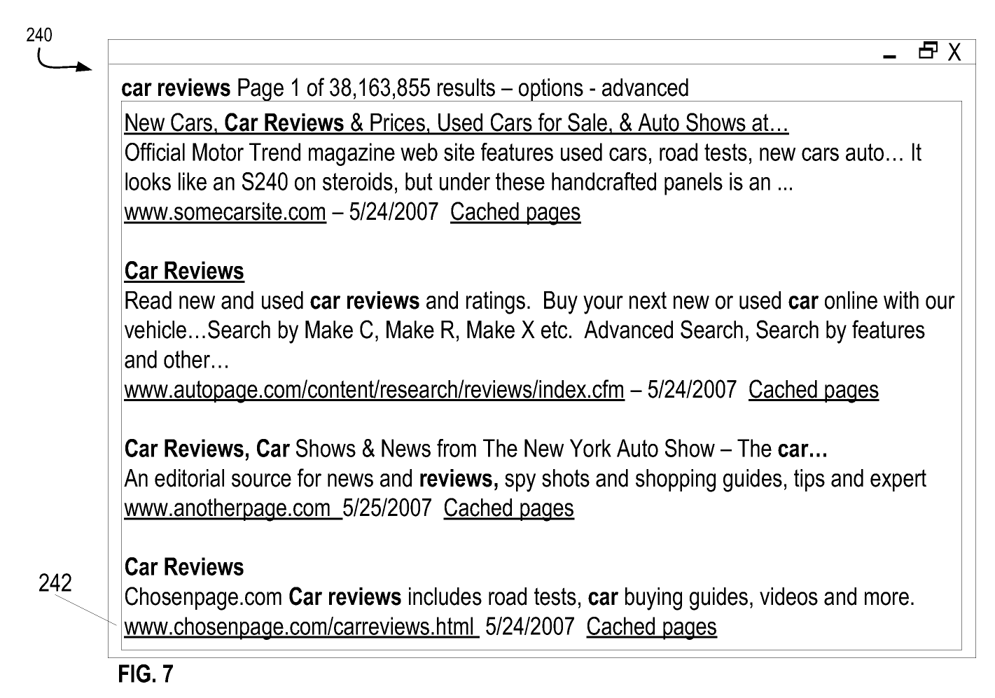

Starting with FIG. 6, a simulated screen 220 is shown of an exemplary web page in an original form prior to alteration. The web page contains various sections with hyperlinks to car review information, such as a featured road test 222, best cars 224, road tests 226, buying guides 228, auto shows 230, editors 232, and video gallery 234. Suppose as the web site owner, you want to use some of the techniques described herein to reorder where the sections show up on the page based upon what are perceived to be the user's interests. For example, if a user is more interested in videos, the videos should be displayed near the top, and the other parts in a less prominent position. Suppose the web page has been implemented with the techniques described in FIGS. 3-5. Now, suppose a user is using a search engine, and comes across a search result that contains a link to this web page of discussion. FIG. 7 is a simulated screen 240 of an example of such a search result that contains a link 242 to the web page of FIG. 6 in the results.

Notice that the page in the hypothetical example, www.chosensite.com/carreviews.html, is the fourth result. For some reason, the user clicks on the link for this page. At this point, the techniques described in FIGS. 3-5 can then be used to infer why the user clicked on the link for the page and alter the selected page accordingly. Before the page is rendered, a server or other process responsible for the page extracts from the request the referrer (in this hypothetical example, suppose it is http://www.somesearchengine.com/results.aspx?q=car+reviews) and the current URL (in this case http://www.chosensite.com/carreviews.html) and it executes the same search. As the owners of this web page, a set of keywords that are relevant to the page and that map to sections of the page have been identified in advance, including “videos”, “guides”, “reviews”, “tests”, “buying”, and “shows”. Taking the search results, the results pointing to the chosen page and all of the results that come before it in the result set are analyzed. Using the algorithm outlined earlier in FIG. 5, two word sets are obtained. Because “review”, “tests”, and “guides” appear in all four of the top results (where ours is the fourth), those are labeled as bad words; however, “videos” and “buying” appear only in the fourth result (our result), and not in the first three results, and thus those are labeled as good words. In the chosen car reviews page, as part of its implementation each of the parts on the page have been labeled to correspond to one of these keywords. Now that an inference can be made from the analysis that “videos” and “buying” are most important to the user, the page can be reordered accordingly and presented to the user.

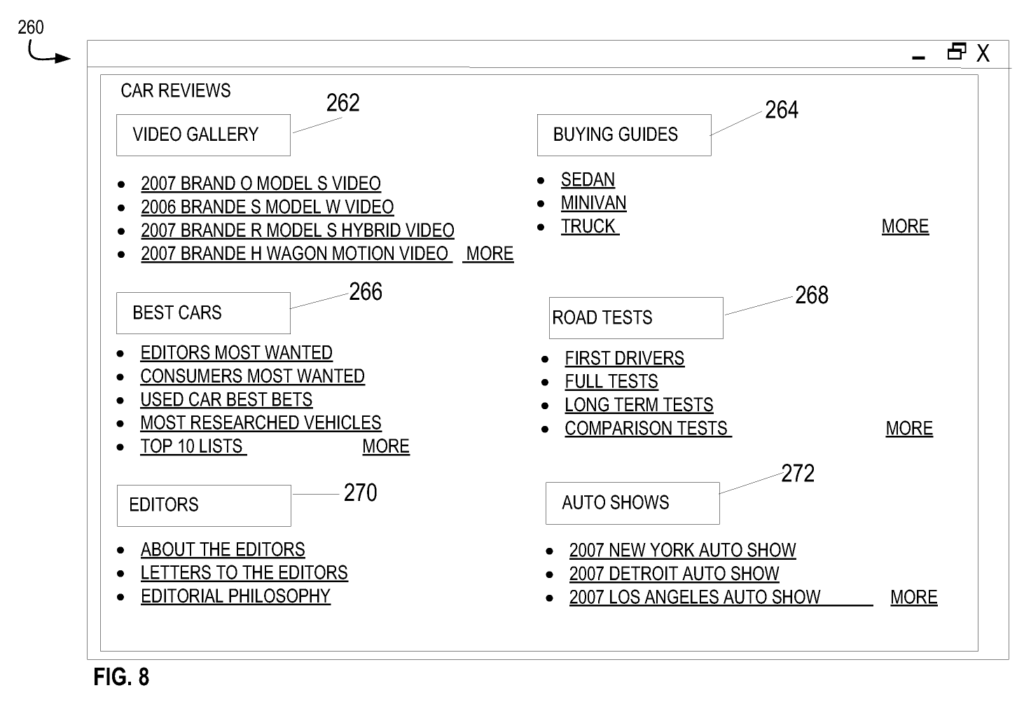

Thus, after the analysis is performed on the referring search results page and the web page is altered based upon the analysis, the altered form of the web page is shown to the user. An example of how this could look using our hypothetical example is shown in the simulated screen 260 of FIG. 8. It will be appreciated that the example screens shown in FIGS. 6-8 are just examples to help illustrate some of the concepts herein, and that many other possible alterations could be made to web pages using these techniques.

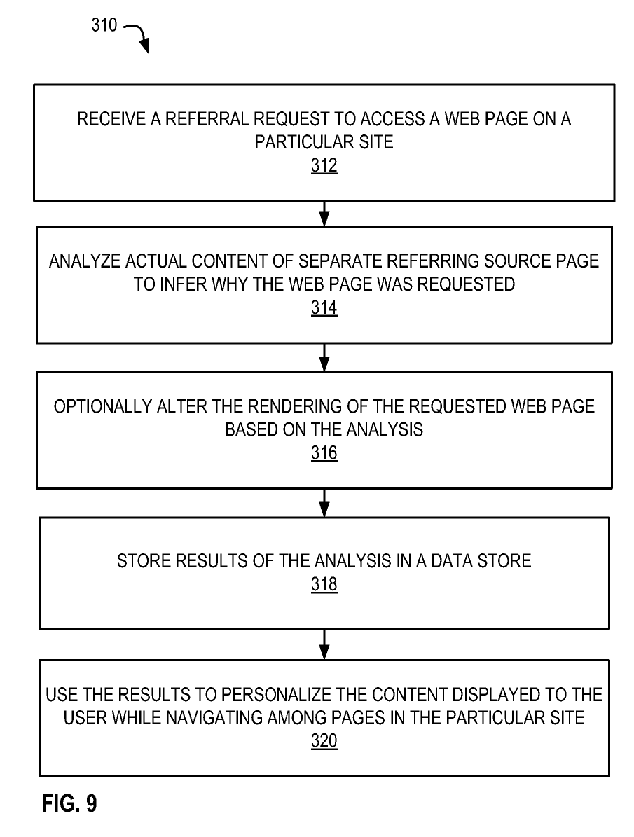

Turning now to FIGS. 9-13, some other implementations of analyzing and/or using information obtained from referring web pages are described. FIG. 9 is a process flow diagram 310 for one implementation illustrating the stages involved in using an analysis of a referring page for personalizing a user's experience throughout the site. A referral request to access a web page on a particular site is received (stage 312). The actual content of the separate referring source page is analyzed to infer why the web page was requested (stage 314). A rendering of the requested web page can optionally be altered based upon the analysis (stage 316). The results of the analysis are stored in a data store (stage 318). The results in the data store are then used to personalize the content displayed to the user while navigating among pages in the particular site (stage 320). Alternatively or additionally, the information can be saved in a user profile that is used on later visits to the site to personalize the content for the user.

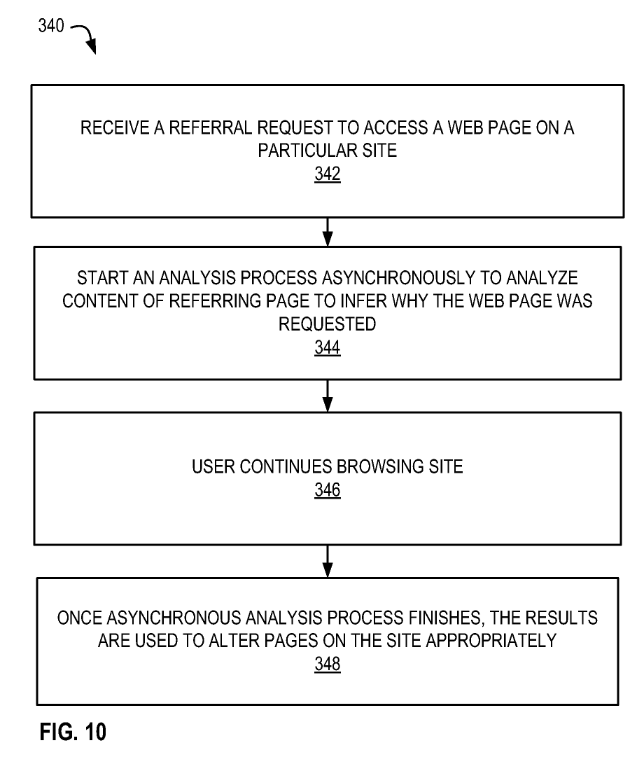

FIG. 10 is a process flow diagram 340 for one implementation illustrating the stages involved in asynchronously analyzing content contained in a referring web page to a particular site and associating the analysis results with the current session on the particular site. A referral request to access a web page on a particular site is received (stage 342). An analysis process is started asynchronously to analyze content of the referring page to infer why the web page was requested (stage 344). The user continues browsing the site (stage 346). Once the asynchronous analysis process finishes, the results are used to alter the pages on the site appropriately (stage 348). For example, the next page and/or later pages the user visits on the site can be altered as appropriate based upon the information. As another example, the current page the user is viewing can be updated according to the new information. One example of how the current page can be updated includes using technology such as AJAX implemented in the page, where the browser augments the currently displayed page asynchronously based upon the results of the analysis.

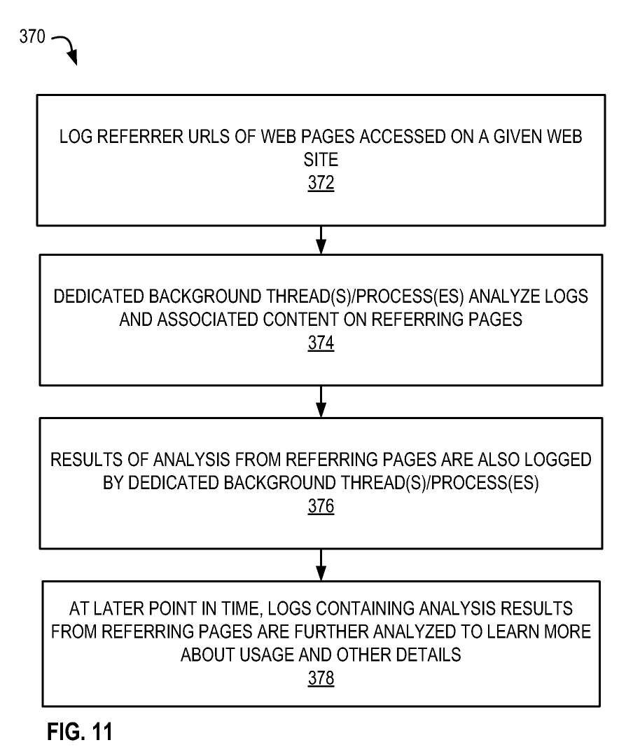

FIG. 11 is a process flow diagram 370 for one implementation illustrating the stages involved in logging referring information for later analysis. The referrer URLs of web pages accessed on a given web site can be logged (stage 372). Dedicated background thread(s)/process(es) then analyze the logs and associated content on the referring pages (stage 374). The results of the analysis from the referring pages are also logged by dedicated background thread(s)/process(es) (stage 376) or analyzed immediately for further analysis. The analysis results from the referring pages and/or the logs are further analyzed to learn more about usage and other details (stage 378). For example, the logs can be used for a more intense form of path analysis, to influence a site redesign, to learn more about customer demographics, and so on.

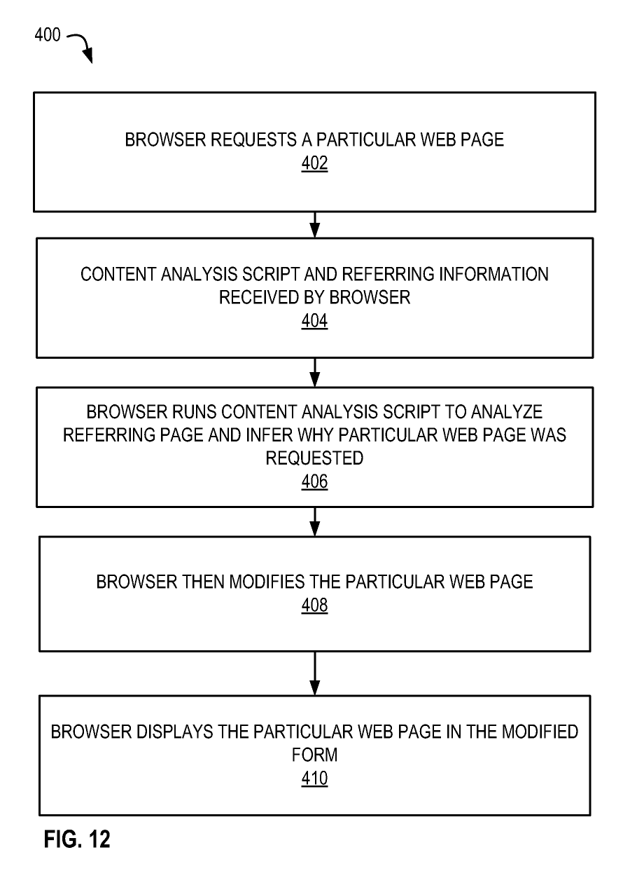

FIG. 12 is a process flow diagram 400 for one implementation illustrating the stages involved in handling the alteration of the web page using a client-side script. The browser requests a particular web page (stage 402). The content analysis script and referring information is received by the browser (stage 404). The browser runs the content analysis script to analyze the referring web page and infer why a particular web page was requested (stage 406). The browser then modifies the particular web page (stage 408) and displays the particular web page in the modified form (stage 410). In one implementation, DHTML or another technique for dynamically modifying the user interface of the web page is used to modify the particular web page.

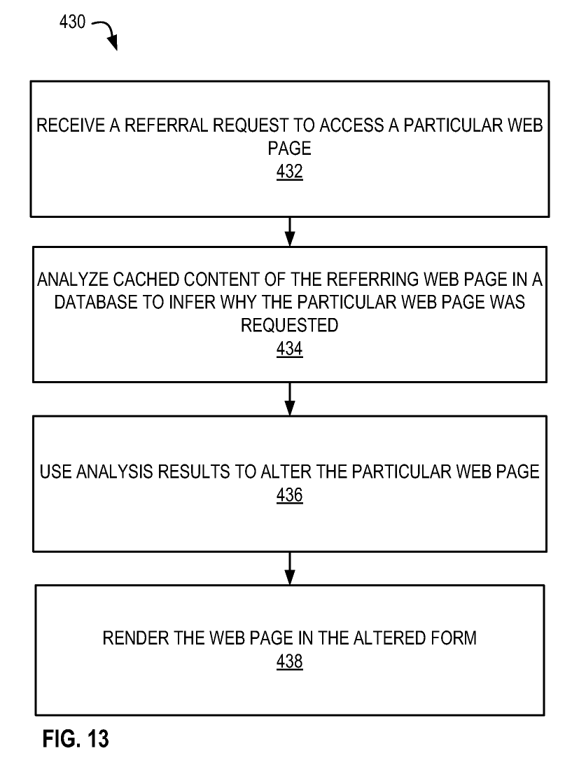

FIG. 13 is a process flow diagram 430 for one implementation illustrating the stages involved in using cached results to optimize analysis of referring web site content. A referral request is received to access a particular web page (stage 432). The cached content of the referring web page is accessed in a database to infer why the particular web page was requested (stage 434). By accessing the cached content in a database instead of the current live version of the web page, processing resources can be saved. The analysis results are then used to alter the particular web page (stage 436), and the web page is then rendered in the altered form.

As shown in FIG. 14, an exemplary computer system to use for implementing one or more parts of the system includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as ROM, flash memory, etc.) or some combination of the two. This most basic configuration is illustrated in FIG. 14 by dashed line 506.

Additionally, device 500 may also have additional features/functionality. For example, device 500 may also include additional storage (removable and/or non-removable) including, but not limited to, magnetic or optical disks or tape. Such additional storage is illustrated in FIG. 14 by removable storage 508 and non-removable storage 510. Computer storage media includes volatile and nonvolatile, removable and non-removable media implemented in any method or technology for storage of information such as computer readable instructions, data structures, program modules or other data. Memory 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 500. Any such computer storage media may be part of device 500.

Computing device 500 includes one or more communication connections 514 that allow computing device 500 to communicate with other computers/applications 515. Device 500 may also have input device(s) 512 such as keyboard, mouse, pen, voice input device, touch input device, etc. Output device(s) 511 such as a display, speakers, printer, etc. may also be included. These devices are well known in the art and need not be discussed at length here.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A method for altering web site content based upon information contained in a referring page comprising the steps of:
receiving a referral request to access a web page;
determining a source of the referral request;
performing an analysis of content contained in the source to infer why the web page was requested;
generating an altered form of the web page based upon the analysis; and
rendering the web page in the altered form.

2. The method of claim 1, wherein the source of the referral request is determined by accessing an HTTP_REFERER header of an HTTP request.

3. The method of claim 1, wherein the source of the referral request is a search engine result page.

4. The method of claim 3, wherein the performing the analysis step comprises the step of:
analyzing at least a portion of words in a listing containing a link to the web page in the search engine result page.

5. The method of claim 4, wherein the performing the analysis step further comprises the step of:
analyzing at least a portion of other listings in the search engine result page to identify some differences in content from the listing containing the link to the web page that was chosen.

6. The method of claim 1, wherein the generating step comprises the step of:
analyzing an existing form of the web page;
determining whether at least one alteration should be made to the web page based upon the analysis; and
when the determining step reveals that the at least one alteration should be made, making the determined alteration to the web page.

7. The method of claim 1, wherein the web page is a dynamic web page that is generated from a database.

8. The method of claim 1, wherein the web page is based upon a static web page file.

9. The method of claim 1, wherein the analysis of content contained in the source is performed against a cached copy of the source.

10. A computer-readable medium having computer-executable instructions for causing a computer to perform the steps recited in claim 1.

11. A method for personalizing a user experience on a web site based upon an analysis of content on a referring web page comprising the steps of:
receiving a referral request to access a web page on a particular site;
performing an analysis of content of a referring source page that sent the referral request to infer why the web page was requested;
storing the results of the analysis in a data store; and
using the results of the analysis to personalize the content displayed to a user while navigating among a plurality of web pages on the particular site.

12. The method of claim 11, further comprising:
altering a rendering of the web page based upon the analysis.

13. The method of claim 11, wherein the performing the analysis step is performed asynchronously while the user browses other pages on the particular site.

14. The method of claim 13, wherein once a notification is received that the asynchronous process has finished performing the analysis, the results are stored in the data store and used to personalize the content displayed to the user.

15. The method of claim 11, wherein the analysis of content contained in the referring source page is performed against a cached copy of the referring source page.

16. The method of claim 11, further comprising:
storing a link to the referring source in the data store.

17. The method of claim 16, further comprising:
repeating the receiving step, performing step, storing the results step, using step, and storing the link step for a plurality of web pages; and
analyzing the results of the analysis and the links to the referring source that are stored in the data store to learn more about site usage.

18. A method for analyzing content on a referring search engine web page to infer why a particular web page was requested comprising the steps of:
creating a first catalog that contains words used in search results other than a requested web page;
creating a second catalog that contains words used in a search result for the requested web page;
creating a list of bad words from the first and second catalogs;
creating a list of good words from the first and second catalogs;
filtering the list of good words and the list of bad words down to just keywords that are relevant to the requested web page; and
using the filtered list of good words and the filtered list of bad words to modify the requested web page.

19. The method of claim 18, wherein the list of bad words contains text that appears in the search result for the requested web page and also in the search results for other pages than the requested web page.

20. The method of claim 18, wherein the list of good words contains text that appears only in the search result for the requested web page.
